(19) United States
(12) Patent Application Publication
(10) Pub. No.: US 2022/0369614 A1
(43) Pub. Date: Nov. 24, 2022

(54) NON-CHEMICAL SPRAY DEVICE FOR INSECTS, PESTS AND GERMS

(71) Applicant: Jay White, College Station, TX (US)

(72) Inventor: Jay White, College Station, TX (US)

(21) Appl. No.: 17/567,559

(22) Filed: Jan. 3, 2022

Related U.S. Application Data
(60) Provisional application No. 63/191,572, filed on May 21, 2021.

(51) Int. Cl. A01M 3/00; A01M 13/00; A01M 5/02

(52) U.S. Cl. CPC A01M 3/007; A01M 13/00; A01M 5/02; A01M 2200/01

(57) ABSTRACT

The present invention relates to a portable insect and pest control and spray device. The device uses a non-chemical germicidal light for killing insects and pests. The device comprises a spray nozzle for scattering insects, while a vacuum attachment sucks and removes the dead insects and pests. A spray wand of the device can be positioned in hidden and hard-to-reach areas for scattering and killing insects and pests. Various types of germicidal lights such as ultraviolet light, blue light or white light are used. The device allows users to target a specific area with increased precision, including those areas that are often concealed or inaccessible.

### CROSS-REFERENCE TO RELATED APPLICATION

The present application claims priority to, and the benefit of, U.S. Provisional Application No. 63/191,572, which was filed on May 21, 2021 and is incorporated herein by reference in its entirety.

### FIELD OF THE INVENTION

The present invention relates generally to the field of insect and pest control devices. More specifically, the present invention relates to a non-chemical spray device and method for killing and removing bugs, pests and insects even from hidden and hard to reach places. The spray device of the present invention is a professional insect and pest spray device that emits a germicidal light, a pressurized air/aerosol spray and a suction force. Additionally, the germicidal light kills insects and pests, the pressurized air disturbs and scatters the insects and pests and a vacuum attachment creates a suction force which sucks the killed insects and pests up into the device. The device can be operated using controls provided on a control box positioned on a pump tank. The device does not use chemicals for killing insects and germs, and provides the advantage of removing the dead insects and pests. Accordingly, the present disclosure makes specific reference thereto. Nonetheless, it is to be appreciated that aspects of the present invention are also equally applicable to other like applications, devices and methods of manufacture.

### BACKGROUND

By way of background, pests and insects such as ants, spiders, millipedes, centipedes, etc., and other insects and pests move around the ground and may enter the indoors through the walls of houses and other avenues. Similarly, mosquitoes and flies can also enter an enclosed area and may become a nuisance and cause illness to people around them. Generally, in order to control these pests or insects, a liquid control agent in which an active ingredient is dissolved and dispersed in an appropriate solvent, such as water, is sprayed around a house or applied to a wall surface. However, the challenge that people face with existing sprayer devices is that they are not able to target specific areas with precision when insects are hiding in a specific area. Further, the liquid control agent penetrates into the ground immediately after being sprayed, and does not reach the specific area where the pests are hiding.

Furthermore, conventional spray devices use chemicals for flushing out insects to locate hotspots. The chemicals used in such spray devices can be harmful to humans and thus can create harmful effects when used inside homes, hospitals and other enclosed areas. Further, conventional sprayer devices make it difficult to directly spray pests in a narrow area. An operator may not be able to reach such narrow areas, and it becomes hard to locate pests and insects in such areas. Thus, conventional spray devices do not provide the means to locate insects and pests in narrow areas.

Further, using conventional spray devices or other insect devices poses the challenge of removing the dead insects. Typically, a user has to manually remove insects, which is both challenging and time-consuming. Thus, the present invention has been made in view of the above circumstances as there is not an effective device and method for forcing insects out of their hiding places effectively without chemicals.

Therefore, there exists a long felt need in the art for an insect spray device that allows users to target a specific area with increased precision, including areas that are often concealed or inaccessible. There is also a long felt need in the art for an insect spray device that can provide suction to remove insects from a specific area. Additionally, there is a long felt need in the art for an insect spray device that uses a non-chemical method for killing bugs, insects and pests. Further, there is a long felt need in the art for an insect spray device that forces insects out of hidden and hard-to-reach areas. Furthermore, there is a long felt need in the art for an insect spray device that can be operated and customized as per a user's wants and/or needs. Finally, there is a long felt need in the art for a professional grade insect and pest control sprayer that improves the accuracy and efficiency of insect and pest removal and is safe for humans.

The subject matter disclosed and claimed herein, in one embodiment thereof, comprises a non-chemical insect and pest control device. The non-chemical insect and pest control device scatters, kills and sucks insects, pests and germs. More specifically, the control device comprises a spray wand that has a sprayer head, which includes a nozzle spray and a light emitter. The nozzle spray releases pressurized air or aerosol spray for scattering insects and pests in a target area and the light emitter emits germicidal light for killing insects and pests in the target area. The spray wand is connected to a pump tank through a hose pipe, wherein the pressurized air or aerosol spray is pumped from the pump tank and operations of the light emitter and the nozzle spray are controlled through a control button disposed on a box controller. Further, a vacuum attachment is secured along the length of the spray wand for providing suction and removal of the dead insects and pests in the target area.

In this manner, the novel insect sprayer device of the present invention accomplishes all of the foregoing objectives and provides a relatively safe, easy and convenient spray device for users to target a specific area with increased precision, including those areas that are often concealed or inaccessible. The present invention offers a professional grade pest control sprayer designed to improve accuracy and efficiency. Further, insects are killed and flushed easily using a non-chemical means, which is safe for both humans and the environment.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable and non-chemical insect spray device. The non-chemical insect spray device is configured to scatter, kill and suck insects, pests and germs. More specifically, the insect spray device comprises a spray wand having a sprayer head that includes a nozzle spray and a light emitter, wherein the nozzle spray is configured to release pressurized air or aerosol spray for scattering insects and pests in a target area, and the light emitter is configured to emit germicidal light for killing insects and pests in the target area. The spray wand is connected to a pump tank through a hose pipe, wherein the pressurized air or aerosol spray is pumped from the pump tank and operations of the light emitter and the nozzle spray can be controlled through a control button disposed on a box controller. Further, a vacuum attachment is integrally or removably-secured along the length of the spray wand to provide suction and removal of the dead insects and pests within the target area.

In yet another embodiment of the present invention, a method for killing and removing dead insects and pests in a target area using an insect spray device is described. The method includes the steps of initially positioning a spray wand of the device in or near the target area, then releasing pressurized air through a nozzle disposed at an end of the spray wand to scatter insects or pests in the target area, emitting germicidal light from a light emitter to kill the insects and pests, and activating a vacuum attachment to suck and remove the dead insects and pests from the target area to effectively clean the area.

In yet another embodiment of the present invention, an insect and pest control device is disclosed. The device includes a spray wand connected to a tank through a hose pipe, the wand has an adjustable distal end, a spray head detachably-secured to the distal end, the spray head having an adjustable light emitter lens configured to emit germicidal short-wavelength visible light or Ultraviolet light for killing germs and pests and a nozzle to spray pressurized air or an aerosol spray for dispersing insects and pests in a hidden area. The spray wand also has an integrated or detachably-secured vacuum attachment for creating suction to suck and remove any dead insects and pests from the hidden area.

In yet another embodiment, the insect and pest control device comprises a knob to control and adjust the wavelength and brightness of the emitted germicidal light. The wavelength of the emitted light can be ultraviolet light having a wavelength in the range of 365-370 nm, UV-C light having a wavelength in the range of 100-280 nm, UV-B light having a wavelength in the range of 280-315 nm or a short wavelength of visible blue or white light.

In yet another embodiment of the present invention, the spray device of the present invention has a built-in battery for providing power to the light emitter which emits germicidal light. The wavelength of the germicidal light can be adjusted using a turning knob disposed on a box controller of the spray device.

In yet another embodiment of the present invention, the spray device is portable and provides a non-chemical treatment for insects and pests. The device can be used in homes, business areas, hospitals and other outdoor areas. The sprayer device works as a professional pest control sprayer.

The improved insect device of the present invention offers the addition of a light, pressurized air and a vacuum attachment for a bug sprayer. The sprayer device comprises a sprayer head with a light and adjustable lenses/bulbs of varying types, such as LED, blue light, UV, etc. The sprayer device has a vacuum attachment that runs the length of the spray wand and enables the suction of insects from a specific area. Furthermore, the device also has an aerosol spray wand attachment that is the length of the spray wand, that releases the pressurized/compressed air to create a disturbance for the pests. Furthermore, the sprayer device has a box configuration on the side of the device to control the light option.

The advantage of the insect and pest control device of the present invention is that it contains rechargeable batteries that power the light emitter to emit germicidal light, which kills insects and pests and offers both pressurized air and suction for the removal of dead insects and pests. The device allows users to target a specific area with increased precision, including those areas that are often concealed or inaccessible.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the insect and pest control device of the present invention in accordance with the disclosed architecture;

FIG. 2 illustrates a close-up view of the spray head comprising a nozzle and a light-emitting lens in accordance with the disclosed architecture;

FIG. 3 illustrates a close-up view of the box controller used for controlling the spray device of the present invention in accordance with the disclosed architecture;

FIG. 4 illustrates a perspective view of another embodiment of the insect spray device of the present invention disclosing a vacuum attachment along the length of the spray wand in accordance with the disclosed architecture; and

FIG. 5 illustrates a flow diagram disclosing the steps followed by a user of the sprayer device to eliminate insects and pests from a specified area in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an insect spray device that allows users to target a specific area with increased precision, including those areas that are often concealed or inaccessible. There is also a long felt need in the art for an insect spray device that can provide suction to remove insects from a specific area. Additionally, there is a long felt need in the art for an insect spray device that uses a non-chemical method for killing insects and pests. Further, there is a long felt need in the art for an insect spray device that forces insects to come out of hidden and hard-to-reach areas. Furthermore, there is a long felt need in the art for an insect spray device that can be operated and customized per a user's wants and/or desires. Finally, there is a long felt need in the art for a professional grade insect and pest control sprayer that improves the accuracy and efficiency of insect and pest removal and is safe for humans.

The present invention, in one exemplary embodiment, is a novel insect and pest control device. The device comprises a spray wand connected to a tank through a hose pipe, the wand has an adjustable distal end and a spray head detachably-secured to the distal end, wherein the spray head comprises an adjustable light emitter lens configured to emit germicidal short-wavelength visible light, or Ultraviolet light for killing germs and pests and a nozzle to spray pressurized air or an aerosol spray for dispersing insects and pests in a hidden area. The spray wand also has an integrated or detachably-secured vacuum attachment for creating suction to suck and remove the dead insects and pests from the area.

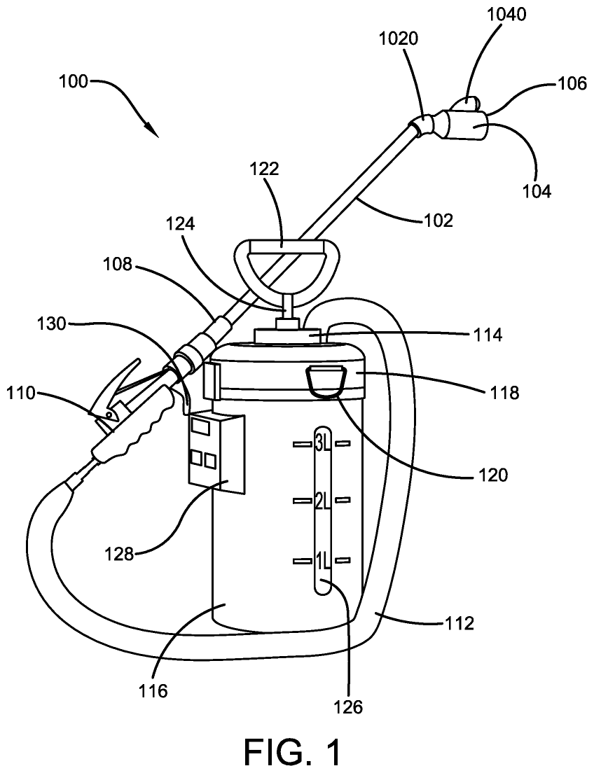

Referring initially to the drawings, FIG. 1 illustrates a perspective view of one embodiment of the insect and pest control device of the present invention. The insect and pest control device 100 of the present invention is designed to release pressurized or compressed air on insects and pests in a specified area, along with emitting short-wavelength visible (blue) light and/or Ultraviolet light. The pressurized air helps in forcing the insects and pests out of their hiding places and the emitted light effectively kills the insects and pests. The insect spray device 100 enables users to target a specific area with increased precision and then scatters insects via a pressurized air wand, such that insects are easily eliminated. Additionally, the spray device 100 flushes out insects from their hiding places. More specifically, the spray device 100 comprises an elongated spray wand 102 which is an aerosol spray wand attachment that releases pressurized, or compressed air for creating disturbance inside a specific area where insects are hidden and need to be removed and killed. The spray wand 102 has a detachably-secured spray head 104 at the flexible distal end 1020 that releases pressurized air from a nozzle 106. At the spray head 104, an adjustable and interchangeable light emitter lens 1040 is configured to emit short-wavelength visible light or Ultraviolet light. The flexible distal end 1020 of the wand 102 allows a user to change the direction of the spray head 104 and thus the pressurized air from the nozzle 106, and wherein the light emitted from the light emitter lens 1040 can be focused and repositioned on even hard to reach areas for killing and removing insects.

The spray wand 102 has a control valve 108 which provides the user with control over the pressure and flow of the pressurized air from the nozzle 106. The control valve 108 can resemble a knob which can be turned to increase or decrease the flow and pressure of the pressurized air from the nozzle 106. Accordingly, based on the flow and pressure, the distance covered by the pressurized air is adjusted as well. Further, the spray wand 102 has a strainer 110 that reduces the clogging, excessive erosion of spray tips and provides for the consistent fluid circulation of the spray device 100. The strainer 110 also filters debris to ensure even, uniform and uninterrupted flow of pressurized air from the nozzle 106. The spray wand 102 is secured to a flexible hose pipe 112 that connects the pump tank 116 to the spray wand 102. The non-chemical aqueous solution stored in the pump tank 116 is used for producing a fine mist of pressurized air, which is transmitted from the pump tank 116 to the spray wand 102 via the hose pipe 112. The hose pipe 112 is connected to the pump tank 116 using a hose connector 114 that allows a leak-proof transmission of the non-chemical aqueous solution.

Based on the preferences of users, the pump tank 116 can be used to store both chemical and non-chemical based fluids such as chemicals, pesticides or any other type of liquid as is known in the art. Further, the pump tank 116 has a check value meter 126 that enables a user to check the level of aqueous solution stored inside the tank 116. There are markings on the check value meter 126 and the tank 116 is transparent along the check value meter 126 area allowing the user to view the level of liquid. The pump tank 116 has a hinged lid 118 for covering the opening of the spray device 100. The lid portion 118 allows the user to access the storage space of the tank 116 to add the chemicals, aqueous solution, etc., inside the tank 116. The tank 116 also has a shoulder strap hook 120 that allows a user to carry the spray device 100 on his or her shoulder as well as to remove the lid 118 from the tank 116. An adjustable handle 122 disposed on the top of the lid 118 allows the user to carry the spray device 100 easily and efficiently.

The spray device 100 also has a plunger rod 124 for creating high pressure inside the tank 116. Specifically, to create high pressure inside the tank 116, the user pulls the plunger 124 up with both hands and then pushes the plunger 124 downwards repeatedly. The plunger forces air through a valve at the base of the cylinder which builds up pressure within the tank 116.

For controlling the operation of the spray device 100, a box controller 128 is disposed on the pump tank 116, which enables users to control the settings of the light or bulb of the adjustable light emitter lens 1040 and other functions of the device 100. The box controller 128, for example, enables users to adjust the brightness or color, based on the wavelength of emitted light from the light or bulb. The box controller 128 also enables users to charge an internal battery using the charging port integrated inside the box controller 128.

To start releasing pressurized air from within the tank 116, a user pulls a trigger 130 which creates a pressure difference which pulls pressurized air from the pump tank 116 through the hose pipe 112 to the spray wand 102. The trigger 130 allows the selective operation of the spray wand 102 by the user. The non-chemical insect spray device 100, preferably exposes the insects, fungi, germs or eggs, spores or substrates, etc., or any other suitable pests as is known in the art to a low wavelength visible and Ultraviolet light by emitting light and releasing pressurized air onto the insects, fungi, germs, eggs or spores, etc.

In operation, the spray wand 102 passes over a desired area for disinfecting and cleaning. As the wand 102, passes over the desired area, the pressurized air from the nozzle 106 and the germicidal light from the light-emitting lens 1040 is emitted onto the insects and germs. In this manner, the pressured air can be directed as a burst of air into target areas to cause an acute reaction and flush out insects and other pests from inaccessible harboring areas. Further, the lens 1040 illuminates said area.

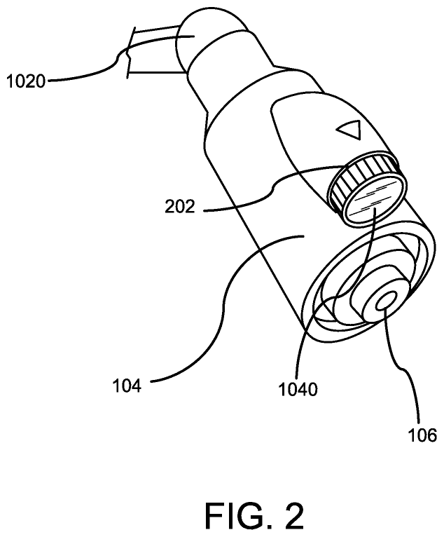

FIG. 2 illustrates a close-up view of the spray head having a nozzle and a light-emitting lens. As shown in FIG. 2, the spray head 104 is connected to a flexible distal end 1020 of the spray wand. The spray head 104 can be positioned in any direction, thereby allowing use of the nozzle 106 and the germicidal light-emitting lens 1040 as per a user's wants and/or needs. The germicidal light emitter 1040 can be one or more of a multicolor Light Emitting Diode, a short wavelength blue light emitter, or a conventional Ultraviolet light bulb. The lens 1040 may further be interchangeable to allow a plurality of different lens 1040 and light types to be used with the device 100. In a preferred embodiment, the germicidal light emitter 1040 emits ultraviolet light having a wavelength in the range of approximately 365-370 nm. Further, in another embodiment, the germicidal light emitter 1040 transmits UV-C light having a wavelength in the range of approximately 100-280 nm and UV-B light having a wavelength in the range of approximately 280-315 nm. The emitted germicidal light attracts and kills insects, germs and pests, etc. It should be appreciated that the light emitter 1040 of the device 100 can be effectively used on spiders, mites, silkworms, different types of mosquitoes and flies, etc., and any other suitable pests as is known in the art. The wavelength of the emitted light can be adjusted using a wavelength adjuster knob 202 which is configured to rotate like a knob to change the wavelength of the emitted germicidal light. Similarly, the knob 202 can be used for adjusting the wavelength to a short wavelength visible light that can kill eggs, larvae, pupae of insects and germs, etc. The nozzle 106 releases pressurized and compressed air for creating a disturbance in an area where insects/germs are present, thereby allowing the insects/germs to move and scatter from the area.

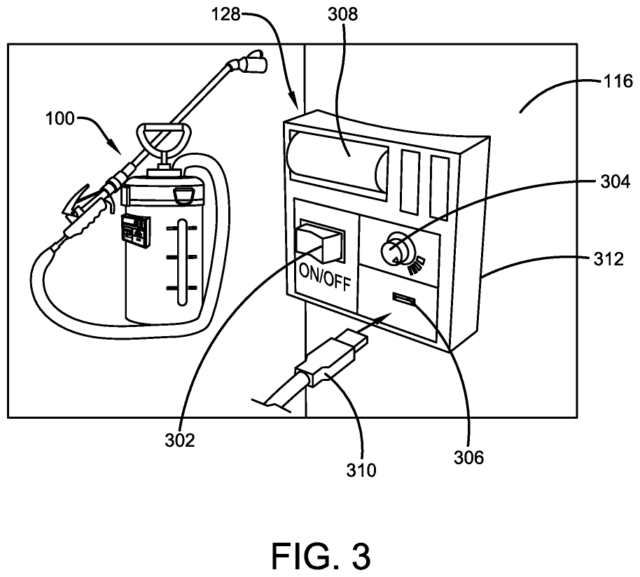

FIG. 3 illustrates a close-up view of the box controller used for controlling the spray device 100 of the present invention. The box controller 128 allows a user to control various components and operations of the spray device 100. The box controller 128 has an ON/OFF switch button 302 that enables a user to switch on or off the germicidal light emitting from the light emitter. The box controller 128 also has an adjustable brightness knob 304 that enables a user to adjust the brightness of the emitted light at the selected wavelength. Additionally, the wavelength of the emitted germicidal light can also be selected and adjusted using the adjustable brightness knob 304. The box controller 128 has a USB charging port 306 which charges an internal battery 308 that provides power to the light emitter/lens 1040. A conventional USB cable 310 can be used for charging the rechargeable battery disposed within the box controller 128. The box controller 128 is typically fixed within a frame 312 disposed on the pump tank 116, or any other suitable position on the spray device 100 as is known in the art.

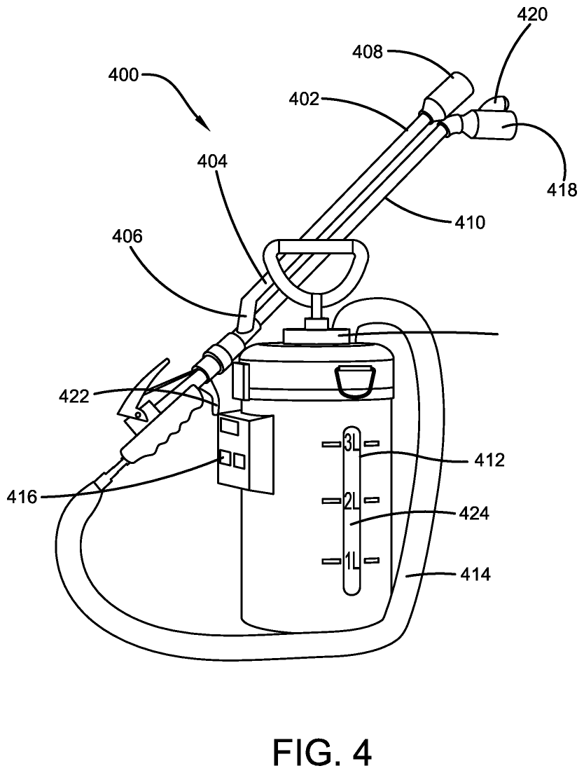

FIG. 4 illustrates a perspective view of another embodiment of the insect spray device of the present invention comprising a vacuum attachment along the length of the spray wand. The advantage of the spray device 400 of the present embodiment is that a user can use the vacuum attachment 402, which runs along the length of the spray wand 410, to drive the vacuum and to generate suction through the vacuum nozzle 408 to remove dead insects, dirt, soil, dust and other debris through the vacuum nozzle 408 and into the insect reservoir 404. The vacuum nozzle 408 sucks the dead bed bugs, insects and other pests to the insect reservoir 404. It should be appreciated that at the same time, the user can also emit the germicidal light from the emitter 420 and spray pressurized air or any aerosol spray using the nozzle 418 onto the targeted surface for killing germs and insects. When the cleaning is completed, the user can move to another area and start releasing the pressurized air or aerosol spray from the nozzle 418. Also, when the cleaning is completed, the user can turn off the power and preferably empty the insect reservoir 404. The vacuum attachment 402 can be operated independently using a vacuum control button 406 or alternatively, the power button 416 can be used for selectively operating the vacuum attachment 402. It should be noted that the operation of emission of germicidal light from the light emitter 420 and pressurized air/aerosol spray from the tank pump 412 through the hose pipe 414 to the nozzle 418 is performed by the trigger 422.

The aqueous solution 424 stored within the tank pump 412 is used for creating the pressurized air/aerosol spray, and is used for scattering and disturbing insects and/or bugs from narrow and hard-to-reach areas. Similarly, the vacuum attachment 402 is used for sucking and removing the dead insects from the narrow and hard-to-reach areas.

It should be appreciated that the spray device 100, 400 of the present invention allows a user to switch between all features of the functioning device, such as the emission of a pressurized air/aerosol spray, a vacuum and germicidal light, a vacuum cleaning mode that activates the vacuum attachment and a cleaning mode that applies the pressurized air and the germicidal light to the target area.

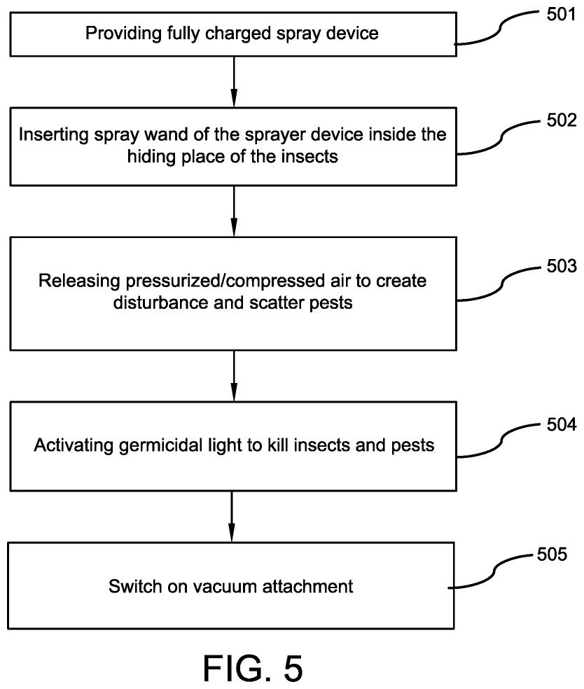

FIG. 5 illustrates a flow diagram showing the steps followed by a user of the sprayer device to eliminate insects and pests from a specified area. As shown in FIG. 5, initially at 501, the sprayer device is fully charged and is provided to eliminate insects and pests that are present and/or hiding in a specific target area. To eliminate insects hiding in the specified target area at 502, the user inserts the spray wand of the sprayer device inside the insects' hiding place. Then at 503, the pressurized or compressed air is released to create a disturbance and scatter the insects hiding inside the specific target area. Then at 504, the user activates the germicidal light to kill or eliminate the insects using the light attachment. Finally at 505, a user switches on the vacuum attachment to suck and remove the dead insects from the specific target area to complete the cleaning process.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “non-chemical insect spray device”, “spray device”, “insect and pest control device”, “ultraviolet light emitting spray device” and “device”, are interchangeable and refer to the non-chemical insect spray device 100, 400 of the present invention.

Notwithstanding the forgoing, the non-chemical insect spray device 100, 400 of the present invention can be of any suitable size and configuration as is known in the art without affecting the overall concept of the invention, provided that it accomplishes the above-stated objectives. One of ordinary skill in the art will appreciate that the size, configuration, and material of the non-chemical insect spray device 100, 400 as shown in FIGS. 1-5 is for illustrative purposes only, and that many other sizes and shapes of the non-chemical insect spray device 100, 400 are well within the scope of the present disclosure. Although the dimensions of the non-chemical insect spray device 100, 400 are important design parameters for user convenience, the non-chemical insect spray device 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An insect and pest control device comprising:
an elongated spray wand with a spray head;
an adjustable light emitter lens secured to the spray head;
a pump tank for storing a non-chemical aqueous solution; and
a flexible hose pipe that connects the pump tank to the elongated spray wand, wherein the non-chemical aqueous solution stored in the pump tank is used for producing a fine mist of pressurized air which is transmitted from the pump tank to the elongated spray wand via the flexible hose pipe, and further wherein the adjustable light emitter lens emits a light to effectively kill pests.

2. The insect and pest control device of claim 1, wherein the spray head comprises a nozzle which releases the fine mist of pressurized air to force pests out of hiding places and narrow areas.

3. The insect and pest control device of claim 1, wherein the adjustable light emitter lens is configured to emit short-wavelength visible light.

4. The insect and pest control device of claim 1, wherein the adjustable light emitter lens is configured to emit ultraviolet light.

5. The insect and pest control device of claim 1, wherein the elongated spray wand comprises a flexible distal end, and further wherein the spray head is detachably secured to the flexible distal end.

6. The insect and pest control device of claim 5, wherein the flexible distal end of the elongated spray wand allows a user to change direction of the spray head.

7. The insect and pest control device of claim 2 further comprising a control valve which allows a user to control pressure and flow of the pressurized air from the nozzle.

8. The insect and pest control device of claim 1, wherein the spray wand comprises a strainer to filter debris for consistent fluid circulation.

9. The insect and pest control device of claim 1, wherein the pump tank comprises a check value meter that enables a user to check level of aqueous solution stored inside the pump tank.

10. The insect and pest control device of claim 1, wherein the pump tank comprises a lid portion that allows users access to an internal cavity of the pump tank and a shoulder strap hook that allows a user to carry the insect and pest control device.

11. The insect and pest control device of claim 10, wherein the lid portion comprises an adjustable handle connected to a plunger rod for creating pressure within the pump tank.

12. The insect and pest control device of claim 11, wherein a user creates pressure within the pump tank by pulling the plunger rod upwards and pushing the plunger rod downwards repeatedly, which forces air through a valve which builds up pressure within the pump tank.

13. The insect and pest control device of claim 12, wherein a user depressing a trigger positioned on the elongated spray wand selectively releases pressurized air from within the pump tank.

14. The insect and pest control device of claim 1 further comprising a box controller disposed on the pump tank.

15. The insect and pest control device of claim 14, wherein the box controller comprises an on/off switch, an adjustable brightness knob, a USB charging port, and an internal battery.

16. An insect and pest control device comprising:
an elongated spray wand with a trigger, a spray head and a nozzle;
a vacuum attachment configured along a length of the elongated spray wand;
an adjustable light emitter lens secured to the spray head;
a pump tank for storing a non-chemical aqueous solution, wherein the pump tank comprises a lid portion that allows users access to an internal cavity and a plunger rod connected to the lid portion for creating pressure within the pump tank; and
a flexible hose pipe that connects the pump tank to the elongated spray wand, wherein the non-chemical aqueous solution stored in the pump tank is used for producing a fine mist of pressurized air which is transmitted from the pump tank to the elongated spray wand via the flexible hose pipe, and further wherein the adjustable light emitter lens is configured to emit short-wavelength visible light or ultraviolet light to effectively kill pests.

17. The insect and pest control device of claim 16, wherein the adjustable light emitter lens emits ultraviolet light having a wavelength in range of 365-370 nm, UV-C light having a wavelength in range of 100-280 nm, or UV-B light having a wavelength of 280-315 nm.

18. The insect and pest control device of claim 16, wherein the pump tank comprises an insect reservoir for retaining pests sucked up via the vacuum attachment.

19. The insect and pest control device of claim 18, wherein the vacuum attachment comprises a vacuum nozzle which is used to suck up pests.

20. A method of using an insect and pest control device for eliminating pests from a target area comprising the steps of:
charging the insect and pest control device to eliminate pests that are present and/or hiding in the target area;
inserting a spray wand of the insect and pest control device inside the target area;
releasing pressurized air to create a disturbance and scatter the pests hiding inside the target area;
activating a germicidal light to kill or eliminate the pests; and
switching on a vacuum attachment to suck and remove dead pests from the target area.
